(19) United States
(12) Patent Application Publication
(10) Pub. No.: US 2007/0083973 A1
(43) Pub. Date: Apr. 19, 2007

(54) Method and article for recycling firefighter turnout gear

(76) Inventor: Christopher Dean Garniewicz, Bluffton, SC (US)

Correspondence Address: MCNAIR LAW FIRM, P.A., P.O. BOX 10827, GREENVILLE, SC, 29603-0827, US

(21) Appl. No.: 11/230,444

(22) Filed: Sep. 20, 2005

(51) Int. Cl. A62B 17/00

(52) U.S. Cl. 2/81

(57) ABSTRACT

This invention is directed towards a method of recycling retired firefighter turnout gear and resulting articles. Typically, retired firefighter turnout gear is shredded and disposed of rather than being recycled. Such disposal is a very wasteful method for dealing with the used turnout gear. Rather than see this gear go to waste, the present invention is directed towards a method of recycling turnout gear into useful articles.

### FIELD OF THE INVENTION

This invention is directed towards the method of recycling retired firefighter turnout gear and the articles produced thereof.

### BACKGROUND OF THE INVENTION

Firefighter turnout gear includes a jacket and pants that are designed to protect a firefighter from heat, flames, and debris encountered when fighting a fire. After use, wear, or age, the turnout gear is “retired” so that it is deemed no longer sufficient to protect a firefighter from his environment. Traditionally, this gear is destroyed, usually through shredding. However, this leads to the waste of still durable material that, rather than being destroyed, could be used for other purposes. Rather than see this gear go to waste, the present invention is directed towards the method of making an article made of the recycled gear and the article itself.

### SUMMARY OF THE INVENTION

The invention is directed towards a method of recycling retired firefighter turnout gear comprising the steps of: providing retired firefighter turnout gear having pants having a pocket and a jacket having cuffs; detaching a pant leg from the pants; cutting the detached pant leg along a line generally parallel to the seam of the pant leg so that the pant leg can be sheeted; cutting out a front section from the pant leg so that the front section includes the pocket; cutting out a back section from the pant leg; cutting out a left and right section and a bottom section from the pant leg; connecting the front section, back section, left section, right section, and bottom section to form a first container having an interior volume for carrying objects; removing the sleeves from the jacket; cutting the jacket along its spine in a line generally parallel to the spine thereby providing a left half and a right half from the jacket; cutting the left half and the right half along a line generally parallel to the spine and generally centered with the former sleeve location thereby forming a front left quarter and front right quarter from the jacket; cutting each sleeve along a line generally parallel to each sleeve so that the sleeve can be sheeted; connecting the sleeves along the end opposite the cuffs; and, connecting the sleeves, front left quarter and front right quarter so that a second container is created for carrying objects.

The invention can also include the steps of: providing retired firefighter turnout gear having a jacket having a zipper generally located at the front of said jacket and generally parallel to the spine of the jacket; connecting said sleeves, front left quarter and front right quarter so that said zipper is located on the upper edge of said second container allows said second container to be secured closed; detaching said pants by cutting along a line generally parallel to said pant leg seams; cutting said detached sleeves along an edge opposite said cuffs; providing retired firefighter turnout gear having pants having a plurality of buttons; removing said plurality of buttons from said firefighter turnout gear pants; and, attaching said plurality of buttons to said top portion of said first or second container so that a carrying means can be attached to said first or second container.

The invention can also include the steps of providing retired turnout gear having suspenders; attaching said suspenders to said first or second container with said plurality of buttons thereby forming a carry means for said first or second container; cutting out interior pocket fabric from said remaining firefighter turnout gear; attaching said interior pocket fabric to the interior of said first or second container thereby forming an interior pocket in said first or second container; providing retired turnout gear having suspenders; cutting out strap openings in the top of said first or second container; and, securing carrying means to said first or second container through said strap openings so that carrying means are provided for said first or second container.

The invention also includes a container made by the method of the invention and a second container made by the method of the invention.

### DESCRIPTION OF THE DRAWINGS

The invention will be more readily understood from a reading of the following specification and by reference to the accompanying drawing. Included are the following drawings:

FIG. 1A is a front view of turnout gear;

FIG. 1B is a front view of one leg of turnout gear pants;

FIG. 1C is a side view of one leg of turnout gear pants;

FIG. 1D is a front view of one segment of turnout gear pants showing a cut pattern;

FIG. 1E is a front view of cut sections from turnout gear pants;

FIG. 2 is a perspective view of an article produced by the invention herein;

FIG. 3 is a front view of a jacket of firefighter turnout gear;

FIG. 4A shows segments cut from the jacket of firefighter turnout gear.

FIG. 4B is a side view of a jacket of firefighter turnout gear;

FIG. 4C is sections of a jacket of firefighter turnout gear;

FIG. 5 is a plan view of an article according to the invention.

FIG. 6 is a perspective view of an article according to the invention;

### DESCRIPTION OF A PREFERRED EMBODIMENT

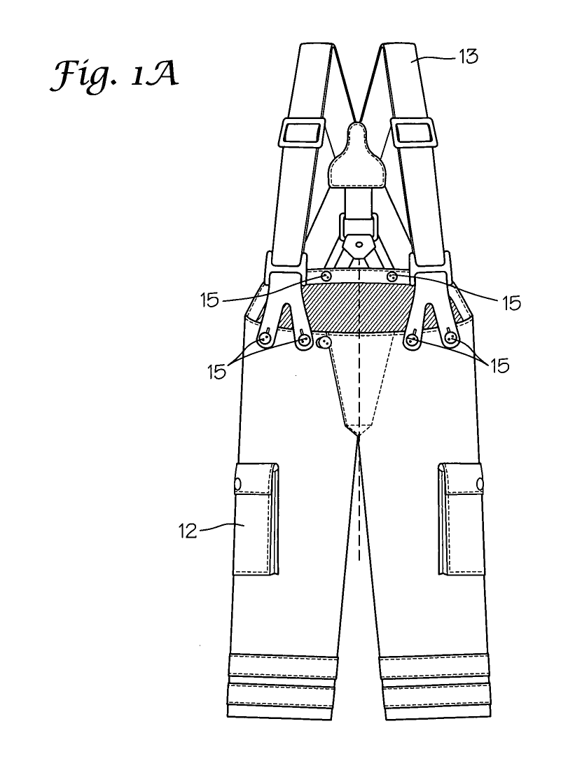

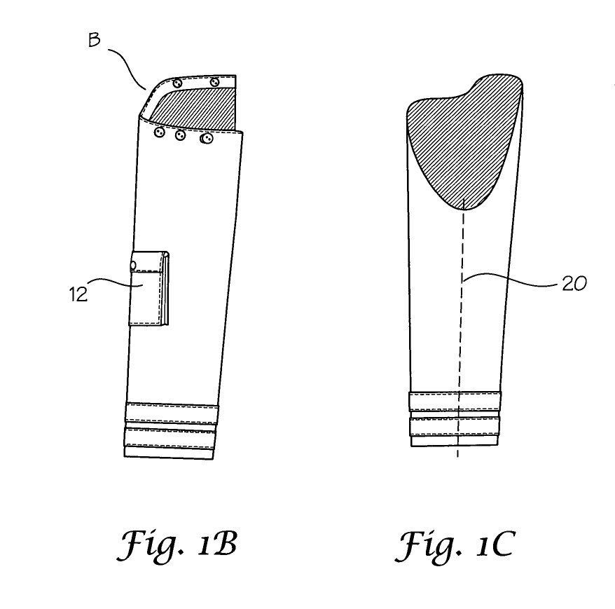

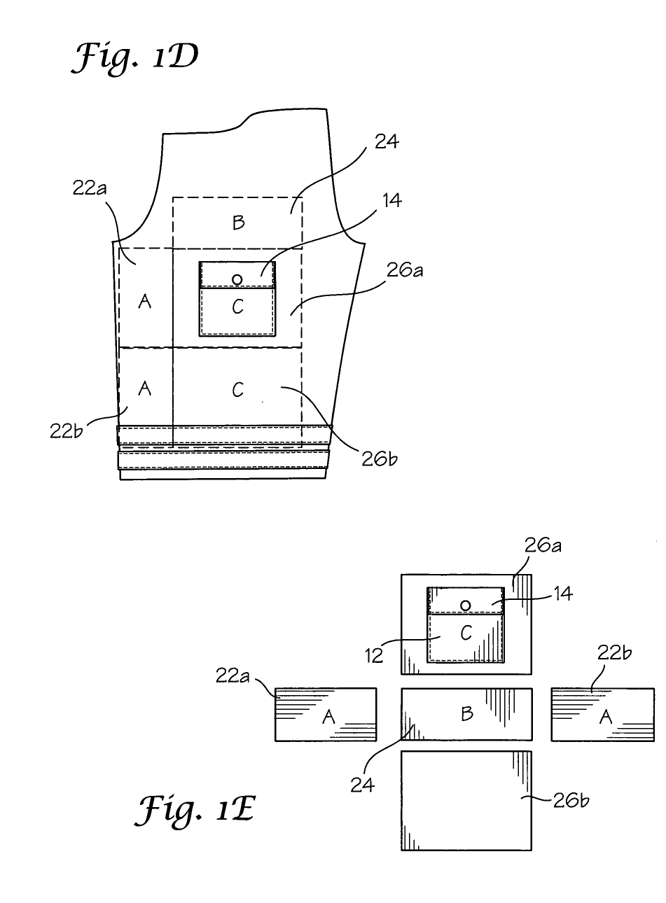

Referring now to FIG. 1A, the method for recycling retired firefighter turnout gear is illustrated. First, retired firefighter gear having pants are provided. The pants can include suspenders 13 which are removed from the pants. The firefighter turnout gear can be made from Nomex, Nomex and Kevlar blend, or Kevlar and PBI blend. The Nomex is generally Nomex III and has a weight between 5.5 oz. and 12 oz. The Nomex and Kevlar blend can contain 25% Kevlar to 75% Kevlar. The Kevlar and PBI blend can contain 35% to 75% Kevlar. With the turnout gear provided, the pants, which can include a pocket 12, are cut so that at least one pant leg is separate as shown in FIG. 1B. Once the pant leg is separated, the pant leg is cut along a line 20 (FIG. 1C) which extends down the back of the pant leg so that the pant leg may be spread out in generally a flat configuration, also termed “sheeted.” It is advantageous for line 20 not to intersect pocket 12 allowing the pocket to be included in the resulting article.

Referring now to FIGS. 1D and 1E, a section of the separated pant leg is shown. The pant leg is then cut so that a left section 22a and a right section 22b of the resulting article are cut from the area of the pant leg shown generally as A. Bottom section 10 is cut from area shown generally as B, whereas a front 26a and a back 26b of the resulting article are cut from the areas shown generally as C.

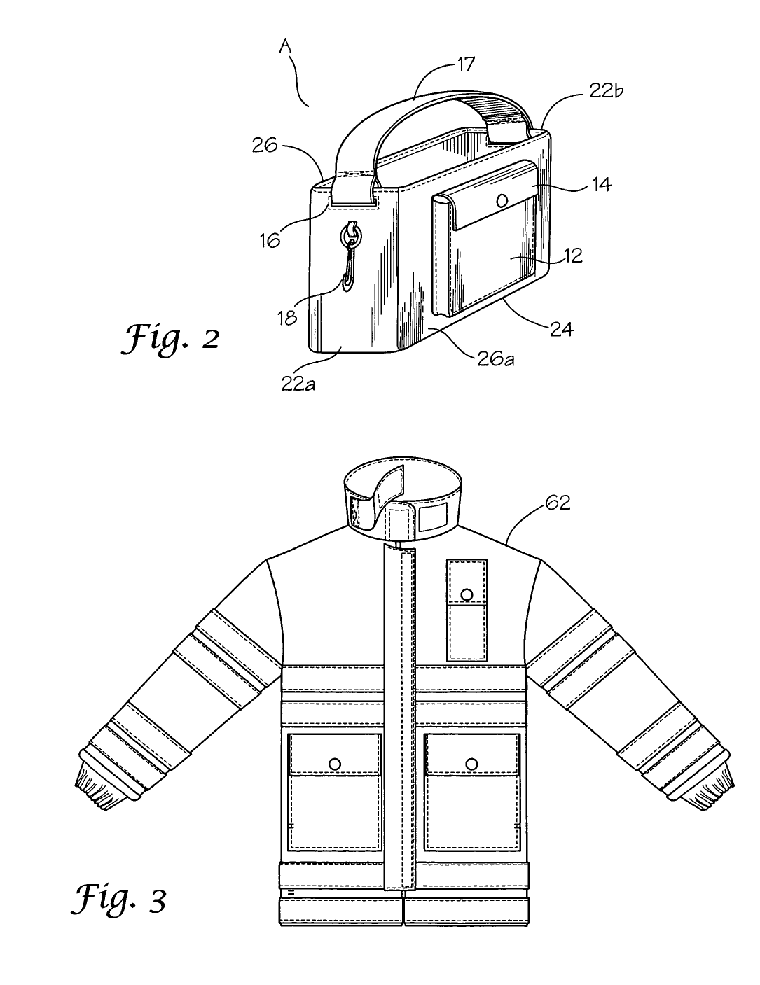

Further, section 26a may be used as the front or back of the resulting article, thus creating pocket 12 (FIG. 2). Due to the possible limitation of a pant leg having only one pocket, both pant legs of the firefighter turnout gear may be necessary to create the resulting article if the article is to have more than one exterior pocket. It should be noted that either front section 26a or back section 26b can be configured so that pocket 12 is interior to the resulting article, rather than exterior. However, such configuration can affect the esthetics since the exterior of firefighter turnout gear and the interior can have different color, texture, and appearance.

Further, the resulting article can include an interior pocket added in addition to exterior pocket 12. Material used to form the interior pocket can be cut from the remaining material of the pant leg and connected to the interior of the resulting article to form an interior pocket. In one embodiment, the material forming the interior pocket is cut from upper thigh or knee area of the separated pant leg.

To assemble an article from the firefighter turnout gear, bottom section 24 is sewn to the front and back sections as well as the left and right sections forming an article. When the pieces of turnout gear comprising the front, back, sides, and bottom sections are sewn together, they create four walls extending upward from the bottom of the article, thereby providing an article produced from a method of recycling retired firefighter turnout gear.

Referring now to FIG. 2, an article made according to the invention is shown having a left section 22a and a right section 22b that are substantially identical in size and shape. A front 26a and back 26b are substantially identical in size and shape and are connected to the left and right sections and to bottom section 10. An exterior pocket 12 may also be located on any of the front, the back, the left section or the right section. The exterior pocket may also be located on each of the front, the back, the left section and the right section of the article or any combination thereof. The pocket may further include a cover 14 for covering the opening defined by the pocket, which may secure itself to the pocket using any means generally known in the art such as snaps, zippers, ties, buttons or Velcro. The article also includes openings 16 that may be located on any two opposing sides of the article for attaching a shoulder strap 17, which may be made of any suitable material known in the art, including without limitation, nylon, cloth or the suspenders used in a firefighter turnout gear itself. The article may also include a spring clip 18 for attaching accessories, such as shoulder straps, keys or any other object which may secure itself to the clip. The spring clip can be exterior or interior to the resulting article.

Referring now to FIG. 3, a jacket of firefighter turnout gear is shown as 62. This jacket may be cut into sections so as to have sections of the jacket that can be recycled into an article. The jacket can have at least one front pocket which can be an upper or lower pocket.

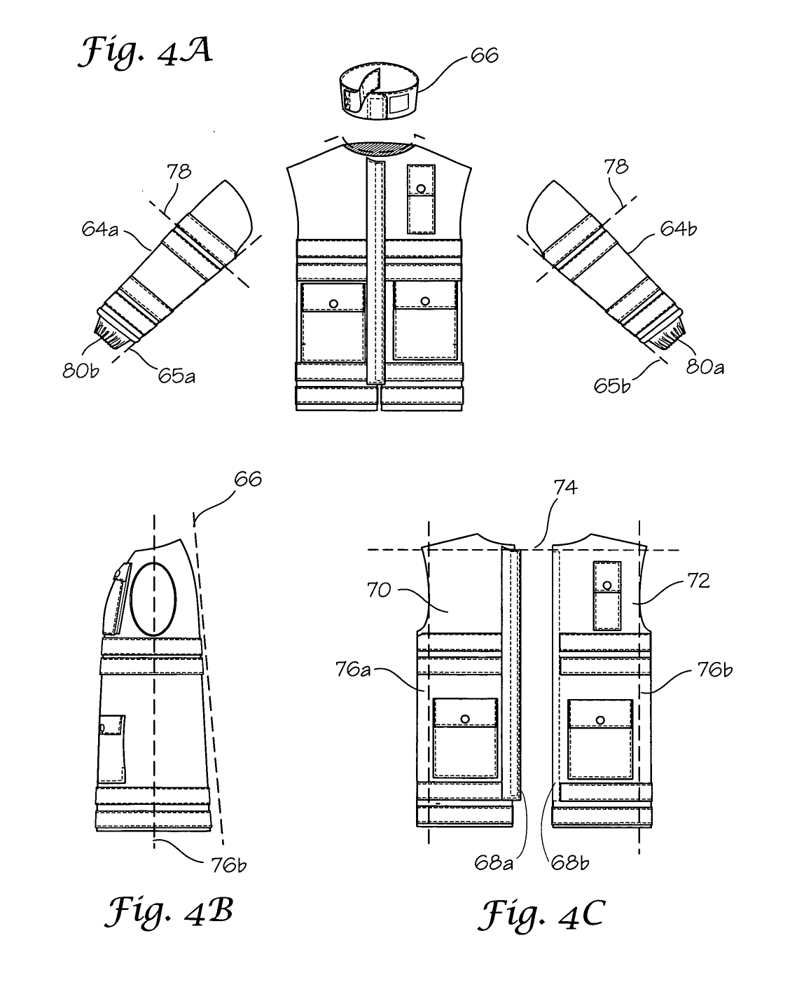

Specifically, left sleeve 64a and right sleeve 64b (FIG. 4) of the jacket at the shoulder. Once removed, the sleeves can be cut or otherwise separated down a seam 65a and 65b, respectively. This cut allows the sleeve to be placed generally flat. Collar 66 may also be removed from the jacket.

Referring now to FIG. 4, the body of the jacket may be cut or otherwise detached along a line extending down the back of the jacket generally vertical to the spine as shown as 66, to provide for two halves to the body of the jacket. Line 66 is in substantially the same plane as zipper 68 of the jacket so that left side 70 of the jacket is separate from right side 72 of the jacket, resulting in two generally equal area sections. Once separated, each side of the jacket may be cut along a top line 74 and an outer line 76a and 76b respectively such that a front right quarter, a front left quarter, a back right quarter and a back left quarter are provided.

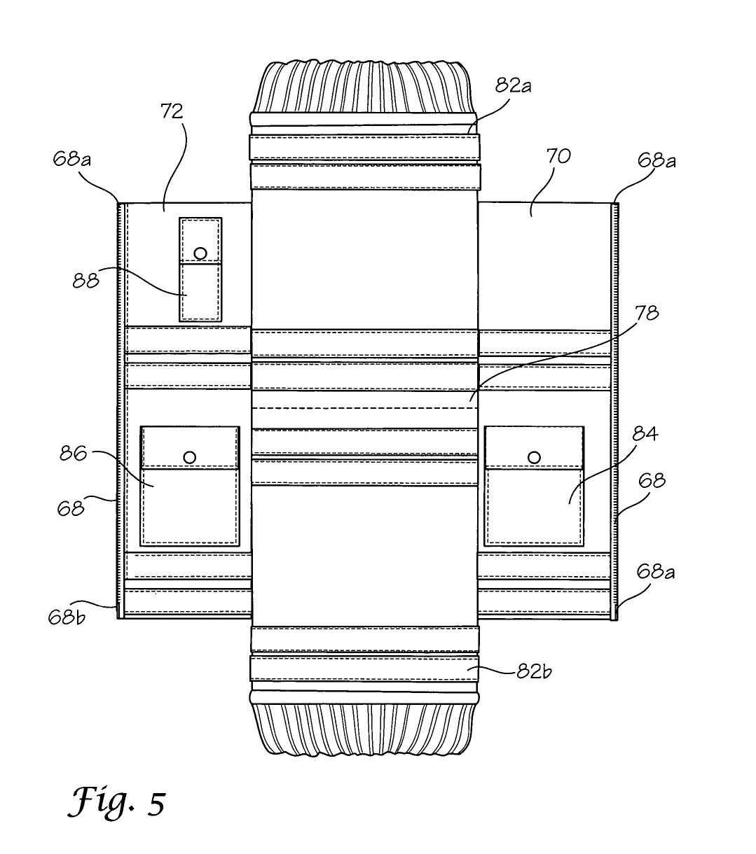

Sleeves 64a and 64b may be cut along a line shown as 78 (FIG. 4). Left sleeve 64b may be sewn or otherwise secured to the right sleeve 64a along cut line 78 so that right cuff 80b forms the other end as shown in FIG. 5. Once joined, left side 70 and right side 72 may be sewn or otherwise secured to the outer edges of the connected sleeve sections so that zipper portions 68a and 68b of front right quarter and front left quarter extends outwardly from the sleeves in such a manner that the zipper portions of the front right quarter and front left quarter align allowing the zipper to close once the article is constructed. The left side and the right side of the jacket may be of appropriate dimensions such that when secured to the sleeves, a sufficient portion of the cuffs 82a and 82b extends beyond the left side and right side of the jacket. In order to create the sides of the article 50 and 52, the sufficient portion of the cuffs may be folded upwardly and sewn or otherwise attached to both the left side of the jacket 70 and the right side of the jacket 72, thereby creating four walls that extend upwardly from bottom 60 which comprise front 48, back 54, left side 50 and right side 52 of an article. The final product is an article that can be zipped, allowing the sides being made from the firefighter turnout gear cuffs to compress to better enclose the interior of the article when zipped.

The interior pockets 84, 86 and 88, respectively, can be included in the interior of the article. These pockets can be included by appropriately cutting and constructing the article so that if they are already attached to the firefighter turnout jacket, they will be included in the resulting article.

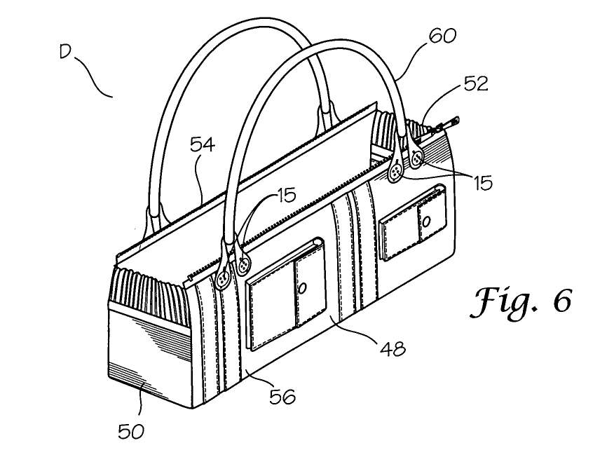

Referring now to FIG. 6, an article comprising recycled firefighter turnout gear is generally shown. The invention includes a front 48, a left side 50, a right side 52, a back 54 and a bottom 56. The dimensions of the front and back may be substantially identical, as may the dimensions of the two sides. The invention may further include buttons 15 for attaching at least one carrying strap 60 which can be made from suspender 13. The article may also use any other means for attaching at least one carrying strap that is generally known in the art including but not limited to snaps, Velcro, clips or openings through which the strap loops. The buttons may be located on both the front and the back of the article in such a manner that at least one carrying strap may be secured to the article. The buttons may also be located on both the left and right sides of the article in such a manner that at least one carrying strap may be secured to the article. At least one carrying strap may be comprised of any suitable material generally known in the art, including but not limited to nylon, cloth, rope, cord, string or the suspenders included in a firefighter turnout gear.

Suspenders 13 can be included in the retired firefighter turnout gear. Typically, these suspenders are attached to the firefighter turnout pant with buttons 15. Such buttons can be used to decorate or provide fasteners for the resulting articles made by recycling firefighter turnout gear. The suspenders can be used for carry handles or carry straps for the resulting articles. For example, buttons can be sewn on the top portion of the article and the suspenders can be attached.

While a preferred embodiment of the invention has been described using specific terms, such description is for illustrative purposes only, and it is to be understood that changes and variations may be made without departing from the spirit or scope of the following claims.

What is claimed is:

1. A method of recycling retired firefighter turnout gear comprising the steps of:
providing retired firefighter turnout gear having pants having a pocket and a jacket having cuffs;
detaching a pant leg from said pants;
cutting said detached pant leg along a line generally parallel to the seam of said pant leg so that said pant leg can be sheeted;
cutting out a front section from said pant leg so that said front section includes said pocket;
cutting out a back section from said pant leg;
cutting out a left and right section and a bottom section from said pant leg;
connecting said front section, back section, left section, right section, and bottom section to form a first container having an interior volume for carrying objects;
removing said sleeves from said jacket;
cutting said jacket along its spine in a line generally parallel to said spine thereby providing a left half and a right half from said jacket;
cutting said left half and said right half along a line generally parallel to said spine and generally centered with the former sleeve location thereby forming a front left quarter and front right quarter from said jacket;
cutting each sleeve along a line generally parallel to each sleeve so that said sleeve can be sheeted;
connecting said sleeves along said end opposite said cuffs; and,
connecting said sleeves, front left quarter and front right quarter so that a second container is created for carrying objects.

2. The method of claim 1 including the steps of:
providing retired firefighter turnout gear having a jacket having a zipper generally located at the front of said jacket and generally parallel to the spine of the jacket; and
connecting said sleeves, front left quarter and front right quarter so that said zipper is located on the upper edge of said second container allows said second container to be secured closed.

3. The method of claim 1 wherein the step of detaching said pant leg from said pants includes the step of detaching said pants by cutting along a line generally parallel to said pant leg seams.

4. The method of claim 1 including the step of cutting said detached sleeves along an edge opposite said cuffs.

5. The method of claim 1 including:
providing retired firefighter turnout gear having pants having a plurality of buttons;
removing said plurality of buttons from said firefighter turnout gear pants; and,
attaching said plurality of buttons to said top portion of said first or second container so that a carrying means can be attached to said first or second container.

6. The method of claim 5 wherein:
said step of providing retired turnout gear includes the step of providing retired turnout gear having suspenders; and,
attaching said suspenders to said first or second container with said plurality of buttons thereby forming a carry means for said first or second container.

7. The method of claim 1 including:
cutting out interior pocket fabric from said remaining firefighter turnout gear; and,
attaching said interior pocket fabric to the interior of said first or second container thereby forming an interior pocket in said first or second container.

8. The method of claim 1 wherein:
said step of providing retired turnout gear includes the step of providing retired turnout gear having suspenders;
cutting out strap openings in the top of said first or second container; and,
securing carrying means to said first or second container through said strap openings so that carrying means are provided for said first or second container.

9. A first container made by the method of claim 1.

10. A second container made by the method of claim 1.

11. A method of recycling retired firefighter turnout gear comprising the steps of:
providing retired firefighter turnout gear having pants having a pocket;
detaching a pant leg from said pants;
cutting said detached pant leg along a line generally parallel to the seam of said pant leg so that said pant leg can be sheeted;
cutting out a front section from said pant leg so that said front section includes said pocket;
cutting out a back section from said pant leg;
cutting out a left and right section and a bottom section from said pant leg; and,
connecting said front section, back section, left section, right section, and bottom section to form a first container having a volume for carrying objects.

12. The method of claim 11 wherein the step of detaching said pant leg from said pants includes the step of detaching said pants by cutting along a line generally parallel to said pant leg seams.

13. The method of claim 11 including:
providing retired firefighter turnout gear having pants having a plurality of buttons;
removing said plurality of buttons from said firefighter turnout gear pants; and,
attaching said plurality of buttons to said top portion of said first or second container.

14. The method of claim 13 wherein:
said step of providing retired turnout gear includes the step of providing retired turnout gear having suspenders; and,
attaching said suspenders to said first or second container with said plurality of buttons thereby forming a carry means for said first container.

15. The method of claim 1 including:
cutting out interior pocket fabric from said remaining firefighter turnout gear; and,
attaching said interior pocket fabric to the interior of said first container thereby forming an interior pocket in said first container.

16. The method of claim 1 wherein:
said step of providing retired turnout gear includes the step of providing retired turnout gear having suspenders;
cutting out strap openings in the top of said first container; and,
securing carrying means to said first container through said strap openings so that carrying means are provided for said first container.

17. A first container made by the method of claim 11.

18. A method of recycling retired firefighter turnout gear comprising the steps of:
providing retired firefighter turnout gear having a jacket having cuffs;
removing said sleeves from said jacket;
cutting said jacket along its spine in a line generally parallel to said spine thereby providing a left half and a right half from said jacket;
cutting said left half and said right half along a line generally parallel to said spine and generally centered with the former sleeve location thereby forming a front left quarter and front right quarter from said jacket;
cutting each sleeve along a line generally parallel to each sleeve so that said sleeve can be sheeted;
connecting said sleeves along said end opposite said cuffs; and,
connecting said sleeves, front left quarter and front right quarter so that a second container is created for carrying objects.

19. The method of claim 18 including the steps of:
providing retired firefighter turnout gear having a jacket having a zipper generally located at the front of said jacket and generally parallel to the spine of the jacket; and,
connecting said sleeves, front left quarter and front right quarter so that said zipper is located on the upper edge of said second container allows said second container to be secured closed.

20. The method of claim 18 including the step of cutting said detached sleeves along an edge opposite said cuffs.

21. The method of claim 18 including:
providing retired firefighter turnout gear having a plurality of buttons;
removing said plurality of buttons from said firefighter turnout gear; and,
attaching said plurality of buttons to said top portion of said second container so that a carrying means can be attached to said container.

22. The method of claim 21 wherein:
said step of providing retired turnout gear includes the step of providing retired turnout gear having suspenders; and,
attaching said suspenders to said second container with said plurality of buttons thereby forming a carry means for said second container.

23. The method of claim 18 including:
cutting interior pocket fabric from said remaining firefighter turnout gear; and,
attaching said interior pocket fabric to the interior of said second container thereby forming an interior pocket in said second container.

24. The method of claim 18 wherein:
said step of providing retired turnout gear includes the step of providing retired turnout gear having suspenders;
cutting strap openings in the top of said second container; and,
securing carrying means to said second container through said strap openings so that carrying means are provided for said second container.

25. A second container made by the method of claim 18.

26. An article comprising:
a front section constructed from retired firefighter turnout gear;
a pocket carried by said front section constructed from retired firefighter turnout gear; and,
a left section, a right section, a back section, and a bottom section constructed from retired firefighter turnout gear so that a container having a volume is provided.

27. The article of claim 26 wherein:
said left section and said right section has an upper compressible portion constructed from the cuff of said right and left sleeves of a jacket of retired firefighter turnout gear.

28. The article of claim 26 having carrying means carried by a plurality of sections of said article constructed from suspenders of said retired firefighter turnout gear.

29. The article of claim 28 having a zipper carried by the upper edge of said front and back sections constructed from the jacket of said retired firefighter turnout gear.

30. The article of claim 26 having an internal pocket located in the interior of said article attached to one of said front section, back section, left section, or right section constructed from said retired firefighter turnout gear.
